(19) United States
(12) Patent Application Publication
(10) Pub. No.: US 2007/0295221 A1
(43) Pub. Date: Dec. 27, 2007

(54) Pressure-Cooking Recipient Provided With A Lid Engageable By Controlled-Deformation And A Corresponding Lid

(76) Inventors: Claire Marie-Aurore Seurat Guiochet, Bretigny (FR); Daniel Jean-Marie Anota, Dijon (FR)

Correspondence Address: James W. Kayden;Thomas, Kayden, Horstemeyer & Risley, L.L.P., 100 Galleria Parkway, N.W., Suite 1750, Atlanta, GA, 30339-5948, US

(21) Appl. No.: 10/579,020

(22) PCT Filed: Nov. 26, 2004
(86) PCT No.: PCT/FR04/03033

§ 371 Date: Jan. 25, 2007

(30) Foreign Application Priority Data
Nov. 27, 2003 (FR) 0313936

(51) Int. Cl. A47J 27/08

(52) U.S. Cl. 99/337

(57) ABSTRACT

The invention relates to a cooking vessel for cooking food under pressure, said vessel comprising:
a cooking bowl (2), a lid (3), and locking means (5); and
support means disposed between the lid (3) and the locking means (5); said cooking vessel being characterized in that:
firstly, the lid (3) and the bowl (2) are shaped so that the lid (3) penetrates into the bowl (2) so as to form an “internal-mount” lid; and
secondly, the support means subdivide the lid (3) into one or more fixed angular sectors (3F), and one or more free angular sectors, said support means and the lid (3) being dimensioned in a manner such as to enable the free sector(s) of the lid (3) to be deformed in controlled manner under the effect of the pressure prevailing in the bowl (2). A cooking vessel for cooking food under pressure.

### TECHNICAL FIELD

The present invention relates to the general technical field of vessels for cooking food under pressure, of the pressure-cooker type, such a vessel comprising a bowl and a lid, and also locking means such as radially-movable jaws or a vertically-movable locking bar, for locking the lid onto the bowl.

The present invention relates more particularly to a cooking vessel for cooking food under pressure, said vessel comprising:

a cooking bowl and a lid, said bowl being provided with engagement means suitable for co-operating with locking means that extend substantially radially over the lid and that are suitable for being moved for locking/unlocking the lid on the bowl; and

support means disposed between the lid and the locking means so that, when the lid is locked on the bowl, the locking means come to bear against the support means.

The invention also relates to a lid designed to be used in the above-mentioned pressure-cooking vessel.

### PRIOR ART

Commonly encountered vessels for cooking food under pressure can be of the type having locking bars or jaws, such locking elements being mounted on the lid in order to close the bowl in airtight manner by means of an interposed sealing gasket.

Such a vessel often has metal parts (lid, locking means, etc.) that are rigid, heavy, robust, and thick, that offer good strength, and that do not deform very much under the effect of the pressure prevailing in the bowl.

Even if the above-mentioned vessels generally give good results from a mechanical point of view, they suffer from non-negligible drawbacks.

Large quantities of raw material are generally necessary for manufacturing such pressure vessels, and they therefore often have high manufacturing costs.

In addition, such vessels, and their component parts are often heavy because of the large quantities of metal used, which makes it difficult for operators to handle them.

### SUMMARY OF THE INVENTION

The objects assigned to the invention are therefore to remedy the various drawbacks listed above, and to propose a novel pressure-cooking vessel which, by offering improved control over the deformation of the lid, makes it possible to reduce the quantity of material used for manufacturing it.

Another object of the invention is to propose a novel pressure-cooking vessel that presents a satisfactory generally pleasing appearance.

Another object of the invention is to propose a novel pressure-cooking vessel that presents good overall strength.

Another object of the invention is to propose a novel pressure-cooking vessel that is well balanced from a mechanical point of view.

The objects assigned to the invention are also to propose a novel lid that is designed to be used in the above-mentioned pressure-cooking vessel.

The objects assigned to the invention are achieved by means of a cooking vessel for cooking food under pressure, said vessel comprising:

a cooking bowl and a lid, said bowl being provided with engagement means suitable for co-operating with locking means that extend substantially radially over the lid and that are suitable for being moved for locking/unlocking the lid on the bowl; and

support means disposed between the lid and the locking means so that, when the lid is locked on the bowl, the locking means come to bear against the support means;

said cooking vessel being characterized in that:

firstly, the lid and the bowl are shaped so that, when the lid is placed onto the bowl, the lid penetrates significantly into the bowl so as to form an “internal-mount” lid, until the locking means come to bear against the engagement means which thus form abutment means for the lid; and

secondly, the support means subdivide the lid into one or more fixed angular sectors that are held by the locking means, and one or more free angular sectors that are not held by the locking means, said support means and the lid being dimensioned in a manner such as to enable the free sector(s) of the lid to be deformed in controlled manner under the effect of the pressure prevailing in the bowl.

The objects assigned to the invention are also achieved by means of a lid designed to be used in the above-mentioned vessel.

### BRIEF DESCRIPTION OF THE DRAWINGS

Other features and advantages of the invention will appear in more detail on reading the following description with reference to the accompanying drawings, which are given by way of non-limiting and illustrative example, and in which:

FIG. 1 is a perspective view of a pressure-cooking vessel of the invention;

FIG. 2 is a cutaway side view of a detail of the pressure-cooking vessel of the invention;

FIG. 3 is a detailed side section view showing how the parts shown in FIG. 2 are arranged relative to one another;

FIG. 4 is a side section view on line A-A of FIG. 2, showing how the lid and the bowl are positioned relative to each other when the vessel is not under pressure;

FIG. 5 is a side section view on line A-A of FIG. 2, showing how the lid and the bowl are positioned relative to each other when the vessel is under pressure; and

FIG. 6 is a plan view of the lid designed for use in the vessel of the invention.

### BEST MANNER OF IMPLEMENTING THE INVENTION

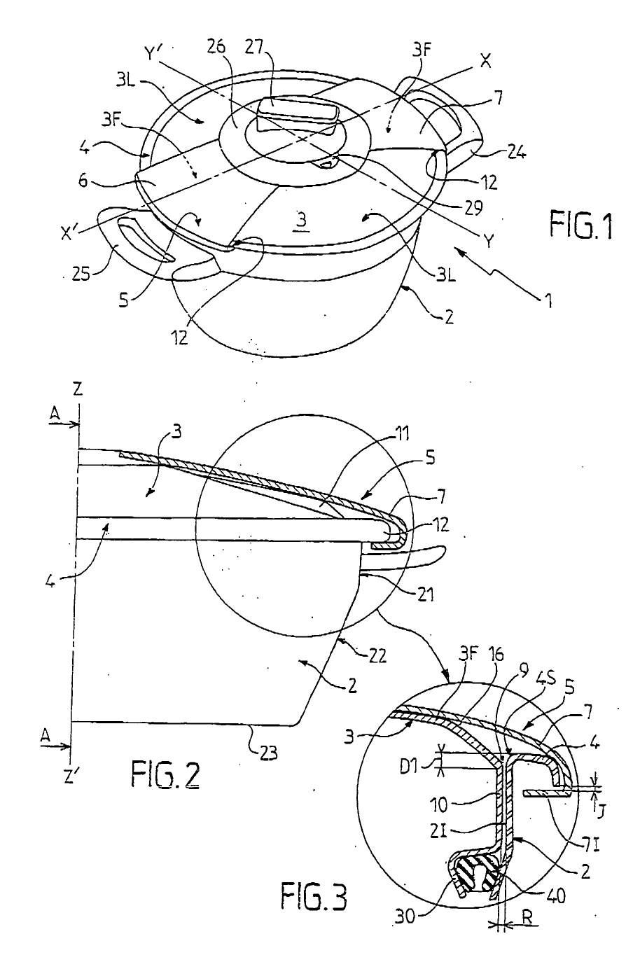

FIG. 1 shows a pressure-cooking vessel 1 comprising a cooking bowl 2 and a lid 3.

The cooking vessel 1 of the invention preferably operates at a relative pressure level of about 20 kilopascals (kPa) above atmospheric, i.e. a pressure level that is lower than generally encountered in pressure cookers, which generally operate at in the range 55 kPa to 90 kPa. This mode of operation thus makes it possible to remove the lid easily at any time during cooking, without deactivating the heat source.

Naturally, the pressure-cooking vessel of the invention could also be designed to operate at higher pressure levels, e.g. levels lying in the range 55 kPa to 90 kPa, without going beyond the ambit of the invention.

In the invention, the bowl 2 is provided with engagement means 12 suitable for co-operating with locking means 5 extending substantially radially over the lid 3, and suitable for moving so as to lock the lid 3 onto the bowl 2 and so as to unlock said lid therefrom.

In a first embodiment of the invention, the locking means 5 are advantageously formed by jaws 6, 7. The bowl 2 is preferably provided with a rim 4, the portion(s) of said rim (4) that is/are situated substantially vertically in register with the jaws 6, 7 forming engagement means 12 for engaging the locking means 5 (FIGS. 1 and 2). The jaws 6, 7 then advantageously bear against the rim 4 in order to lock the lid.

In a second embodiment of the invention (not shown in the figures), the locking means can also be in the form of a locking bar, without going beyond the ambit of the invention. In which case, a locking bar is mounted to move in vertical translation on the lid, with wedging means being interposed between the lid and the locking bar, said wedging means maintaining a predetermined distance between the lid and the locking bar, guaranteeing that the cooking vessel is leaktight. The two ends of the locking bar are advantageously dimensioned so as to co-operate with corresponding lugs that are mounted on the bowl and that form engagement means 12 for engaging the ends of the locking bar. By turning a knob mounted to move in rotation relative to the lid and to the locking bar, the operator can cause said locking bar to move upwards (or downwards) until the locking bar bears, via its ends, against respective bearing surfaces provided for this purpose on the lugs, thereby locking the lid 3 onto the bowl 2. In this embodiment of the invention, the bowl 2 can also be provided with a rim, but said rim does not serve to form engagement means for engaging the locking means.

The description below applies to both of the above-mentioned embodiments.

As shown in FIG. 1, the locking means 5 and, for example, the jaws 6, 7, preferably extend along a substantially radial main axis X-X′.

In a preferred variant, the bowl 2 firstly has a substantially cylindrical top segment 21 and secondly a substantially frustoconical bottom segment 22 that is terminated by the bowl bottom 23 (FIG. 2). The bowl 2 also has an inside wall 2I that defines the internal volume of the bowl that is usable for cooking (FIG. 3).

The bowl 2 advantageously has two handles 24, 25 that are preferably opposite each other and that are, for example, situated substantially on the main axis X-X″ of the locking means 5. Since the handles 24, 25 perform a function independent from the function of the locking means 5, it is not necessary to position the handles in alignment with said locking means. Said handles 24, 25 can thus be positioned anywhere around the entire periphery of the bowl 2.

The cooking vessel also has control means 26 provided with a control knob 27 that is turned in order to cause, in the first embodiment, the jaws 6, 7 (FIG. 1) to move radially.

The control means 26 are advantageously mounted in a recess 28 formed at the centre of the lid 3 (FIG. 6). In particular, they have an actuator mechanism (not shown) arranged to transform the movement in rotation of the control knob 27 into outward or inward movement in radial translation of the jaws 6, 7. The cooking vessel 1 of the invention also has discharge means 29 of the valve type for discharging steam.

In the invention, the lid 2 and the bowl 2 are shaped so that as soon as it is put in place on the bowl 2, the lid 3 penetrates significantly into the bowl 2 so as to form an “internal-mount” lid (FIGS. 3, 4, and 5).

The lid 3 can thus penetrate into the bowl until the locking means 5 come to bear against the engagement means 12, e.g. against the rim 4 of the bowl 2, thereby also forming abutment means for the lid 3 with a view to defining its fixed or abutment position inside the bowl 2.

The lid 3 advantageously comprises a bowl-covering portion 8 that closes the opening in the bowl 2 and that defines or that is terminated by an outer edge 9, e.g. an annular outer edge when the lid 3 is circular.

Particularly advantageously, the bowl-covering portion 8 is extended by a side wall 10 which extends downwards so as to fit the shape of the inside wall 21 of the bowl 2 (FIG. 3) with a small amount of radial clearance R.

Thus, in a preferred variant of the invention shown in FIG. 3, the side wall 10 penetrates into the bowl 2 until one of the jaws 6 or 7 comes into contact with the rim 4 of the bowl 2.

The locking means 5, e.g. the jaws 6, 7 thus form abutment means for the lid 3, enabling it to reach its closure position prior to locking the utensil.

When the lid 3 is in the closed position in which it is closed on the bowl 2, clearance J is advantageously present between the rim 4 of the bowl 2 and the inwardly-extending ends 71 of the jaws 6, 7 (FIG. 3).

The clearance J makes it possible, in particular, to reduce the force required for turning the control knob 27, and to facilitate locking the lid 3.

When the vessel is put under pressure, the lid 3 and the associated jaws 6, 7 rise significantly, and the ends 7I of the jaws 6, 7 come advantageously to bear against the rim 4, thereby locking the lid 3 onto the bowl 2 even more securely. In this configuration, the clearance J is advantageously substantially zero.

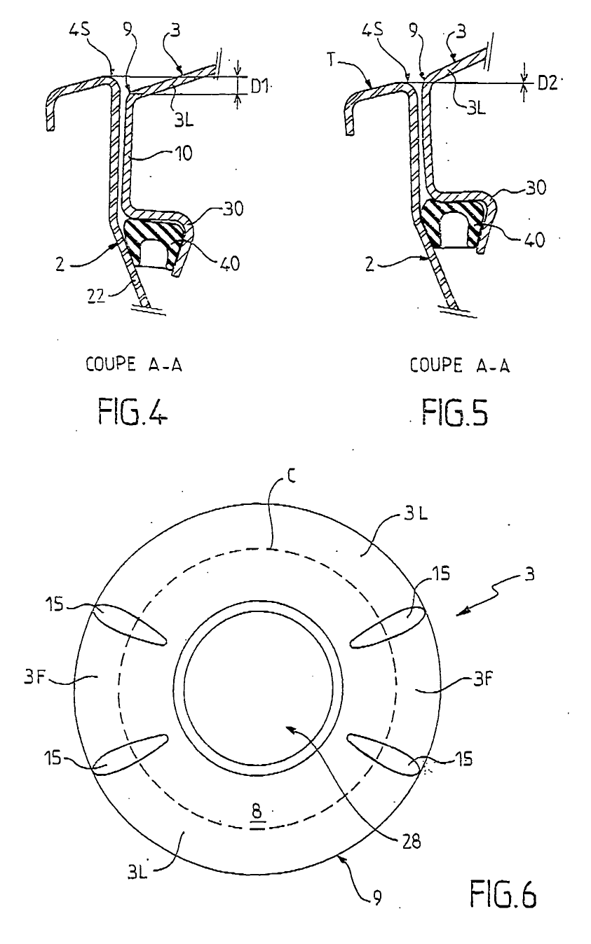

In the first and the second embodiments of the invention, the bottom end of the side wall 10 of the lid 3 advantageously has a fold 30 arranged to receive a sealing gasket 40 (FIGS. 3, 4, and 5). Thus, when the lid 3 is in place on the bowl 2, and when the side wall 10 penetrates into said bowl, the gasket 40, which is of the lip seal type, is advantageously flattened against the inside wall 2I of the frustoconical segment 22 of the bowl (FIG. 4).

Thus, the bowl 2, the lid 3, and the gasket 40 are shaped so that the vessel 1 is leaktight as soon as the locking means 5, e.g. the jaws 6, 7, come to bear against the engagement means 12 (e.g. against the rim 4 of the bowl).

When the lid 3 is locked onto the bowl 2 and the when the vessel 1 is not under pressure, the lid 3 is held in a rest position corresponding to the locking means 5, e.g. the jaws 6, 7 being put into contact with the rim 4 of the bowl.

In the invention, and as shown in FIG. 2, which is a cutaway side view of one half of the vessel 1, support means 11 are disposed between the lid 3 and the locking means 5, e.g. the jaws 6, 7, so that when the lid 3 is locked onto bowl 2, the locking means 5 come to bear against the support means 11.

The support means 11 are advantageously disposed remote from the center of the lid, and they then advantageously subdivide the lid 3 into one or more fixed angular sectors 3F held by and situated substantially under the locking means 5, e.g. the jaws 6, 7, and one or more free angular sectors 3L not held by the locking means 5 and situated, for example, between the jaws 6, 7 (FIG. 1).

The locking means 5 then advantageously bear simultaneously firstly on the rim 4 of the bowl 2 and secondly on the support means 11, thereby imparting good overall strength to the vessel 1 (FIG. 2).

In the invention, the support means 11 and the lid 3 are dimensioned so as to enable the free sector(s) 3L that are not held by the locking means 5 to be deformed under the effect of the pressure prevailing in the bowl 2.

Under the effect of said pressure, the fixed sector(s) cannot deform because they are held firmly by the locking means 5, via the support means 11 interposed between the lid 3 and said locking means 5. Conversely, the free sector(s) 3L, which are not held by the locking means 5, can deform.

Thus, by acting firstly on the dimensioning of the support means 11, in particular on their height, and secondly on the dimensioning of the lid 3, in particular on its height, and on the type of its component material, it is possible to control the deformation of the free sector(s) 3L of the lid 3 relative to the edge of the bowl 4.

Controlling the deformation of the lid then makes it possible to design and manufacture lids that are of smaller thickness but that can deform to a larger extent than generally encountered lids, thereby making it possible to reduce significantly the quantity of raw material that is necessary and the cost of the cooking vessels.

In a preferred variant embodiment, the lid 3 is preferably manufactured from stainless steel and has a thickness preferably lying in the range 0.8 millimeters (mm) to 1.2 mm.

Even more preferably, the thickness of the lid 3 is substantially constant over the entire bowl-covering portion 8 and about 1 mm. The thickness of the lid 3 can naturally vary as a function of the diameter and of the nominal pressure level of the vessel.

The rim 4 of the bowl 2 advantageously has a top limit 4S (FIGS. 3, 4, and 5). Particularly advantageously, the support means 11 are dimensioned so that, when the lid 3 is locked on the bowl 2, and when the vessel 1 is not under pressure, they generate a first predetermined amount of vertical clearance D1 between the to D limit 4S and that fraction of the annular outer edge 9 which defines the free sector(s) 3L.

When the lid is in the rest position, i.e. when the 1 vessel 1 is not under pressure, the first amount of vertical clearance D1 extends over the entire periphery of the vessel 1 between the annular outer edge 9 and the too limit 4S of the rim 4 of the bowl 2, even under the jaws 6, 7 (or under the locking bar) (FIG. 3).

The support means 11 are advantageously dimensioned so that, when the vessel 1 is under pressure, with the lid 3 being locked on the bowl 2, they generate a second amount of vertical clearance D2 between the top limit 4S and that fraction of the annular outer edge 9 which defines the free sector(s) 3L, said second amount of vertical clearance D2 being different from and less than the first amount of vertical clearance D1, the difference between the first amount of clearance D1 and the second amount of clearance D2 resulting from the free sector(s) 3L deforming under the effect of the pressure prevailing in the bowl 2 (FIGS. 4 and 5).

Conversely, since the fixed sector(s) 3F situated under the jaws 6, 7 (or under the locking bar) deform only to a small extent under the effect of the pressure, the clearance existing between the top limit 4S and that fraction of the annular outer edge 9 which defines the fixed sector(s) 3F is not very different from the first amount of clearance D1 (FIG. 3).

Thus, after a heat source has been activated, and when the lid 3 is locked on the bowl 2, the pressure rises progressively inside the vessel 1 and tends to deform the free sector(s) 3L of the lid so that said free sector(s), which is/are initially set back into the bowl 2, tend to rise, thereby moving the annular outer edge 9 towards the rim 4 of the bowl 2.

In an even more preferable variant of the invention, the support means 11 and the lid 3 are advantageously dimensioned so that, when the vessel 1 is subjected to a rated pressure, i.e. to its normal operating pressure (e.g. predetermined by the rating of a valve), the second amount of clearance D2 is substantially zero in those zones of the free sector(s) which are deformed to the largest extent.

In other words, the support means 11 and the lid 3 are advantageously dimensioned and shaped so that, when a rated pressure prevails in the bowl 2, the outer edge 9 of the lid 3 rises and comes flush with, i.e. comes to the same level as, the rim 4 of the bowl.

In the lid zones of maximum deformation, the annular outer edge 9 of the lid 3 then advantageously comes substantially flush with the too limit 4S of the rim 4 of the bowl 2 (FIG. 5).

Preferably, the above-mentioned rated pressure corresponds substantially to a relative pressure of about 20 kPa above atmospheric in the bowl. Naturally, if the pressure inside the vessel 1 exceeds the rated operating pressure, the annular outer edge 9 of the lid 3 can project outwards from the bowl 2 and beyond the top limit 4S.

Otherwise, the top limit 4S of the rim 4 of the bowl being flush with the annular outer edge 9 of the lid 3 imparts a particularly satisfactory pleasing appearance to the vessel 1.

In order to improve the appearance of the cooking vessel 1 of the invention even further, the rim 4 of the bowl 2 advantageously includes an annular top margin T that presents substantially the same external curvature as the bowl-covering portion of the lid 3 (FIG. 5).

Thus, when the cooking vessel 1 is in the rated operating mode, the lid 3 returns automatically to be positioned in alignment with the top margin T of the bowl 2.

In a preferred variant of the first embodiment of the invention, the locking means 5 are formed by two jaws 6, 7 that are substantially symmetrical with each other about the center of the lid (which center is situated on the axis of symmetry Z-Z′) of the vessel 1, said jaws 6, 7 extending substantially radially along the main and diametrical axis X-X′ (FIGS. 1 and 2).

The jaws 6, 7 are advantageously formed from stainless steel in order to obtain a better coefficient of stiffness and in order to impart improved rigidity to said jaws.

The thickness of the jaws 6, 7 preferably lies in the range 1.5 mm to 2 mm in order to obtain a good compromise between a quantity of metal used that is as small as possible, and mechanical rigidity that is good. In addition, the jaws 6, 7 are preferably mounted in mutually opposing manner so as to make it possible to impart good mechanical balance to the cooking vessel.

Preferably, the respective thicknesses of the lid 3 and of the jaws 6, 7 are not determined independently from each other, in order to obtain good overall strength for pressure cooker.

The movement of the jaws 6, 7 for locking (or unlocking) the lid is preferably radial and inward (or outward).

In this configuration, the zones of the free sector(s) 3L that undergo deformation to the largest extent when the vessel is under pressure are situated along a secondary axis Y-Y′ that is substantially perpendicular to the main axis X-X′ along which the jaws 6, 7 extend (FIG. 1).

The second amount of clearance D2 thus preferably decreases substantially to zero in the vicinity of a midplane (i.e. a plane that separates the lid 3 into two half-lids) that is perpendicular to the main axis X-X′ when the pressure inside the vessel 1 is at its rated value.

Naturally, it is possible to consider forming a cooking vessel that has more than two jaws, e.g. four jaws mounted at 90° relative to one another.

In which case, the zones in which deformation is greatest are situated at places geometrically equidistant from successive jaws.

The support means 11 are advantageously formed by bearing ramps 15 that are preferably oblong in order to offer an improved area of contact with the locking means 5 (FIG. 6).

It is thus possible, by controlling the height of the bearing ramps, to decide to have the annular outer edge 9 of the lid 3 come flush with, or stand proud from, or be set back from the top limit 4S of the rim 4 of the bowl, when the rated operating pressure prevails inside the bowl 2.

Preferably, the dimensioning of the support means 11, and in particular the height of the bearing ramps 15 is determined in association with the deformation capacities of the lid 3, so that the combined effects of the support means 11 and of the deformation of the lid 3 result, when the vessel is under a rated pressure, in the second amount of clearance D2 decreasing to zero, and in the outer edge 9 of the lid 3 coming flush with the rim of the bowl.

In a preferred variant, the bearing ramps 15 are formed by projections 16 provided on the lid 3, projecting from the outside surface of the lid 3 substantially vertically in register with the locking means 5 (FIG. 3). The projections 16 can advantageously be obtained by stamping the lid 3.

Naturally, the bearing ramps 15 can also be formed by separate parts (not shown in the figures) that can be welded, bonded with adhesive, or riveted to the lid 3.

The bearing ramps 15 formed in this way preferably extend from the annular outer edge 9 of the lid 3 to the centre of the lid (FIG. 6), i.e. in a radial direction.

In a variant (not shown in the figures), it is also possible to consider providing bearing ramps 15 that are formed or mounted on the jaws 6, 7, it then advantageously being possible for said bearing ramps 15 to be in the form of projections provided under the jaws 6, 7.

In the preferred variant of the invention in which the locking means 5 comprise two jaws 6, 7, the support means 11 are preferably formed by two pairs of bearing ramps 15 (FIG. 6). Each pair of bearing ramps 15 is then advantageously situated under a corresponding jaw 6, 7. Such a configuration thus guarantees better contact between the lid 3 and the jaws 6, 7 and makes it possible to obtain a cooking vessel 1 that is well balanced mechanically.

The bearing ramps 15 also make it possible to provide an empty space between the lid 3 and the jaws 6, 7.

The two bearing ramps 15 in any one pair are thus preferably situated in the same plane that is substantially perpendicular to the axis of symmetry Z-Z′ (FIG. 2) and distributed under the jaws 6, 7 in a manner sufficiently far apart to enable the distribution of the forces to be improved.

It is naturally possible, without going beyond the ambit of the invention, to increase further the number of bearing ramps 15 under each jaw 6, 7, or to provide a single, large-width bearing ramp 15 under each jaw 6, 7.

In order to improve further the area of contact between bearing ramps 15 and the locking means 5, said locking means preferably present a sufficient width, of about 15 mm, the choice of this width resulting from a compromise between firstly the need to obtain good contact between the jaws 6, 7 and the bearing ramps 15 and secondly concern to reduce the quantity of raw material used and to make a lid 3 that is sufficiently light in weight.

The height of the bearing ramps 15 is preferably about 4 mm. Naturally, all of these dimensions are given merely by way of non-limiting example, and other values could be considered without going beyond the ambit of the invention.

In order to improve further the overall strength of the cooking vessel 1 of the invention, the two pairs of bearing ramps 15 are preferably positioned remotely from the center of the lid 3, on same geometrical circle C whose centre is situated on or in the vicinity of the axis of symmetry Z-Z′ (FIG. 6).

The cooking vessel of the invention thus makes it possible, through the support means 11, to control the deformation of the lid so that it becomes possible to make lids of small thickness, requiring 2 limited quantity of raw material for manufacturing them, and being of low cost, while also guaranteeing good operating safety.

Another advantage of the vessel of the invention is that it offers good overall strength, guaranteeing user safety.

Operation of the cooking vessel 1 of the invention is described below for the first embodiment of the invention, with reference to FIGS. 1 to 6.

In order to put the lid 3 in place on the bowl 2, it is necessary to open the jaws 6, 7. To do that, the user turns the central control knob 27 so as to cause the jaws 6, 7 to move radially outwards. After the lid 3 has been put in position on the bowl 2, and after the side wall 10 of the lid 3 has been inserted into bowl 2, until the jaws 6, 7 come into contact with the rim 4 of the bowl, the jaws 6, 7 must be locked.

To do that, the user actuates the control knob 27 in a rotation direction opposite from the direction corresponding to opening, so as to cause the jaws 6, 7 to move radially inwards until said jaws come to clamp against the rim 4 of the bowl 2. Once locked, the cooking vessel 1 can be positioned on a heat source so as to generate an increase in the pressure prevailing in the bowl. The increase in the pressure of the cooking vessel 1 can be accompanied by significant deformation of the free sector(s) 3L, and, for example, of the two free sectors 3L situated between the jaws 6, 7.

When the cooking vessel has reached its rated operating pressure, corresponding, for example, to a relative pressure of about 20 ka above atmospheric inside the bowl, the second amount of clearance D2 tends to decrease to zero in the zones of maximum deformation of the lid that are situated in the vicinity of the plane perpendicular to the main axis X-X′ along which the jaws 6, 7 extend.

Conversely, the amount of clearance between the top limit 4S of the rim 4 of the bowl and the annular outer edge 9 defining the fixed sector(s) 3F remains substantially identical to the first amount of clearance D1 corresponding to the rest position of the lid 3 when the vessel is not under pressure.

The rated operating pressure is maintained substantially constant by means of the steam discharge means 29. When the heat source is deactivated and the steam contained in the vessel is discharged and the relative pressure decreases to zero, the lid 3 resumes its rest position, and the first amount of clearance D1 is present again between the annular outer edge 9 of the lid 3 and the top limit 4S of the rim 4 of the bowl, over substantially the entire periphery of the lid 3.

### SUSCEPTIBILITY OF INDUSTRIAL APPLICATION

The invention is susceptible of industrial application in designing and manufacturing household pressure-cooking utensils, in particular pressure cookers.

1. A cooking vessel for cooking food under pressure, said vessel comprising:
a cooking bowl and a lid, said bowl being provided with engagement means suitable for co-operating with locking means that extend substantially radially over the lid and that are configured for being moved to lock and unlock the lid on the bowl; and
support means disposed between the lid and the locking means so that, at a time when the lid is locked on the bowl, the locking means come to bear against the support means;
the lid and the bowl being shaped so that, at a time when the lid is placed onto the bowl, the lid penetrates significantly into the bowl form an “internal-mount” lid, until the locking means come to bear against the engagement means which form abutment means for the lid; and
the support means subdividing the lid into one or more fixed angular sectors that are held by the locking means, and one or more free angular sectors that are not held by the locking means, said support means and the lid being dimensioned to enable the free sector(s) of the lid to be deformed in controlled manner under the effect of the pressure prevailing in the bowl.

2. The vessel of claim 1, wherein the bowl-covering portion of the lid defines an outer edge, and the bowl is provided with a rim that has a top limit, the support means being dimensioned so that, at a time when the lid is locked on the bowl and when the vessel is not under pressure, they generate a first predetermined amount of vertical clearance between said top limit and that portion of the outer edge which defines the free sector(s), and, at a time when said lid is locked on the bowl and when the vessel is under pressure, they generate a second amount of vertical clearance between said top limit and said portion of the outer edge, the difference between the first amount of clearance and the second amount of clearance resulting from the free sector(s) deforming under the effect of the pressure prevailing in the bowl.

3. The vessel of claim 2, wherein the support means and the lid are dimensioned so that, at a time when the vessel is subjected to a rated pressure, the second amount of clearance is substantially zero in those zones of the free sector(s) which undergo the largest amount of deformation, the outer edge then coming substantially flush with the top limit of the rim of the bowls.

4. The vessel of claim 1, wherein the support means are formed by bearing ramps.

5. The vessel of claim 4, wherein the bearing ramps are formed by projections provided on the lid, substantially vertically in register with the locking means.

6. The vessel of according to claim 4, wherein the bearing ramps are formed by separated parts.

7. The vessel of claim 1 wherein locking means are formed by two jaws that are substantially symmetrical to each other about the center of the lid, said jaws extending substantially radially.

8. The vessel of claim 2, wherein the engagement means are formed by the portion(s) of the rim of the bowl that is/are situated substantially vertically in register with the jaws, the jaws coming to bear against the rim in order to lock the lid.

9. The vessel of claim 4, wherein the support means are formed by two pairs of bearing ramps, each pair of bearing ramps being situated under a corresponding jaw.

10. The vessel of claim 9, wherein the two pairs of bearing ramps are positioned on the same geometrical circle.

11. The vessel of claim 1, wherein the locking means are formed by a locking bar that is suitable for co-operating with corresponding lugs mounted on the bowl, said lugs forming engagement means for engaging the locking means.

12. The vessel of claim 2, wherein the bowl-covering portion of the lid is extended by a side wall that extends downwards so as to fit the shape of the inside wall of the bowl with a small amount of radial clearance.

13. The vessel of claim 12, wherein the bottom end of the side wall of the lid has a fold arranged to receive a sealing gasket.

14. The vessel of claim 2, wherein the rim of the bowl has an annular top margin presenting substantially the same external curvature as the lid.

15. (canceled)

16. The vessel of claim 7, wherein the engagement means are formed by the portion(s) of the rim of the bowl that is/are situated substantially vertically in register with the jaws, the jaws coming to bear against the rim in order to lock the lid.
